(19) United States
(12) Patent Application Publication
(10) Pub. No.: US 2008/0080957 A1
(43) Pub. Date: Apr. 3, 2008

(54) Sliding nut with captive screw

(76) Inventors: Dan L. James, Oakland, TN (US); Joey D. Magno, Cordova, TN (US)

Correspondence Address: HOFFMAN & BARON, LLP, 6900 JERICHO TURNPIKE, SYOSSET, NY, 11791, US

(21) Appl. No.: 11/605,125

(22) Filed: Nov. 28, 2006

Related U.S. Application Data
(60) Provisional application No. 60/848,709, filed on Oct. 2, 2006.

(51) Int. Cl. E04G 25/00; F16B 37/08

(52) U.S. Cl. 411/433

(57) ABSTRACT

A method and apparatus is provided for suspending a strut rack assembly from one or more vertical threaded rods without passing the assembly over the ends of the rods utilizing a snap off one piece nut that includes two portions which are substantially planar structures. Each portion includes an open aperture across the planar structure leading to a threaded portion. One of the portions includes a sliding guide tray which is designed to receive the other portion and includes a screw hole. The other portion includes an inclined surface designed to interact with a screw member provided through the screw hole. In essence, the screw member pushes forward the inclined surface of the other portion so that the threaded portions of the front and second portions tighten around a threaded rod.

### CROSS REFERENCE TO RELATED APPLICATION

This application claims priority to U.S. Provisional Application No. 60/848,709, filed Oct. 2, 2006.

### FIELD OF THE INVENTION

The present invention relates generally to suspended strut members and support thereof, and more particularly to a method and apparatus for suspending extra strut members from threaded rod that has other strut members already suspended from the strut rod, without removing the existing strut members.

### BACKGROUND OF THE INVENTION

In architectural settings, it is often necessary to improve architectural structures by adding, changing or removing certain portions. Such architectural improvements and additions are constantly being made in commercial and industrial settings. More specifically, in many commercial and industrial settings, changes need to be made in modular, steel, aluminum, and fiberglass reinforced plastic framing products and accessories suitable for electrical, industrial, construction and other applications without welding or performing other permanent changes. One of the common problems encountered in changing the modular form of the architectural construction is the removal or addition of horizontal members to the existing threaded rod assemblies. To effectively add or remove horizontal members to existing threaded rod assemblies, such procedure requires the whole assembly to be removed and a new assembly to be installed. Then, the original assembly will be reinstalled, which is very labor intensive, and adds a substantial cost to a work project.

A strut system is a system of horizontally placed channeled strut members suspended from the ceiling on a plurality of vertical threaded rods. The channel strut member has a plurality of holes through which the vertical rods are received as the strut member is raised to the proper elevation. A washer and a threaded nut are run up on the rod to engage the bottom of the strut member or the top of the strut member and support the strut member on the rod. Pipes or electrical cables are supported horizontally on these pipe rack strut members and run horizontally overhead throughout the building.

When architectural improvements, additions or removals require new pipe or electrical hookups, or rerouting, the suspended pipes or electrical cables must be removed or replaced, or new ones added. This procedure often requires expensive periods of shutdowns while the pipe racks are disassembled. In some cases, a second layer or intermediate pipe rack may be installed above the existing one to allow placement of the new pipe or cable before the old ones are removed.

For instance, to install an intermediate pipe rack above an existing one, it is necessary to remove the old strut members from the vertical threaded rod, or to take off the nut and lower the strut members. The intermediate strut member must then be forced over the existing pipe and cable which often requires bending or cutting an existing support rod to allow the intermediate strut member to fit on the rods above the pipe and cable. Then the old lower strut member must be put back into position. This threading procedure alone takes many hours.

One solution has been to provide a split nut device, which can be assembled onsite to support strut members. Various split nut configurations, although not utilized to support strut members, are known in the art. Specifically, there are several patents directed to various split nut configurations.

For instance, U.S. Pat. No. 5,039,266 to Nagayoshi et al. discloses on FIG. 11, a pair of divided nut parts connected by bendable connectors. As can be seen, such device is not suited for supporting a strut member, thereon.

Thus, a simple to manufacture device which is easy to install on a threaded rod with existing strut members without the necessity of removing any members already in place, utilizing channels and trapeze in the suspending hangers is desired.

### SUMMARY OF THE INVENTION

The present invention provides an apparatus for suspending a strut rack assembly from one or more threaded rods without passing the assembly over the end of the shafts. The apparatus includes a substantially planar monolithic body with a top surface, a bottom surface and side edges thereof, and including a receptacle portion preformed with at least a defined narrow joint linked to a detachable slider portion configured to detach and slide into the receptacle portion, the joint defining two access openings extending to an internally threaded portion of the receptacle portion and the slider portion for insertable accommodation of the threaded rod.

Further, the present invention also provides for a hanger nut assembly wherein the receptacle portion has a substantially rectangular perimeter with a pair of raised side edges, each forming a narrow longitudinal upper ridge having a proximate end and a distal end, the distal end curving inwardly to define an angled bend forming a retaining sliding mechanism of a guide tray for accommodating the slider portion.

Additionally, the present invention further provides for a hanger nut assembly including a screw, wherein the proximate end of the longitudinal upper ridge includes a threaded hole to accommodate the screw and a corner of the slider portion includes a slanted surface on a ledge adapted to cooperate with the screw and move the slider portion toward the receptacle portion and clamp around the threaded rod as the tip of the screw presses along the slanted surface.

A still further embodiment of the invention provides for a hanger nut assembly wherein the joint is formed with a specified tensile strength to maintain connection of the slider portion with the receptacle portion during transportation and to easily to snap off and detach by hand.

The present invention also provides for a hanger nut assembly wherein a captive screw is provided in the threaded hole so as to prevent disengagement from said body.

The present invention further provides for a method of supporting a strut having a threaded rod extending therethrough, by providing a preformed substantially planar monolithic body including a receptacle portion and a slider portion joined at a pair of linking joints, the linking joints defining two access openings extending to an internally threaded portion of the receptacle portion and the slider portion for insertable accommodation of the threaded rod, snapping the slider portion off from the receptacle portion, wherein the receptacle portion includes a pair of upper ridge with a bend forming a retaining sliding mechanism of a guide tray for accommodating said slider portion and a threaded hole, guiding the internally threaded portion of the receptacle portion around the threaded rod, guiding the internally threaded portion of the slider portion into the guide tray of the receptacle portion, wherein a corner the slider portion includes a slanted surface adapted to cooperate with the screw and drive the slider portion toward the receptacle portion to clamp around the threaded rod, turning the screw through the screw hole and against the slanted surface to hold the receptacle portion and the slider portion together against the threaded rod, moving the receptacle portion up or down on the threaded rod to a desired position, tightening the screw to securely clamp the receptacle portion and the slider portion together on the threaded rod, and placing a strut member against the body and preferably against a bottom surface of said receptacle portion.

### BRIEF DESCRIPTION OF THE DRAWINGS

FIG. 1 is a perspective view of a preferred embodiment of the present invention;

FIG. 2 is a bottom plan view showing the bottom side of the embodiment as shown in FIG. 1;

FIG. 3 is a side plan view showing the distal end of the embodiment shown in FIG. 1;

FIG. 4 is a perspective view of the embodiment as shown in FIG. 1, wherein the slider portion is being snapped off from the receptacle portion as part of a preferred method of installation;

FIG. 5 is a perspective view of the embodiment as shown in FIG. 1, shows the receptacle portion and the slider portion conjoining together around a threaded support rod as a further step of the preferred method initially shown in FIG. 4;

FIG. 6 is a perspective view of the preferred embodiment shown in FIG. 1, disclosing a further step of the preferred method as shown in FIGS. 4 and 5, with a screw forcing the slider portion to tighten around the threaded rod together with the receptacle portion;

FIG. 7 is a bottom plan view showing another embodiment of the present invention with a different linking joint location;

FIG. 8 is a bottom plan view showing further another embodiment of the present invention with a different linking joint location;

FIG. 9 is a top plan view showing another embodiment of the present invention with a pair of top bent ridges;

FIG. 10 is a end view showing another embodiment of the present invention with a snap-on ridges feature; and

FIG. 11 is a side plan view of another embodiment of the present invention with grooves and ridges on the ledge portion.

### DETAILED DESCRIPTION OF PREFERRED EMBODIMENTS

The monolithically fabricated body 102 includes two portions, a substantially rectangular receptacle portion 400 and a similarly profiled detachable slider portion 300 conjoined by a narrow linking joint 350 and 352. The receptacle portion 400 serves as a guide tray and receives the detachable slider portion 300, thereby forming a nut around a threaded rod 98 positioned between the two engaging portions.

The present invention will be described with reference to the sliding nut assembly shown in the drawings presented here with, but is not limited to this particular embodiment. It is contemplated that a sliding nut assembly within the scope of the present invention can be constructed with various different configurations to receive a threaded support rod. It is further contemplated that the present invention may be utilized in other areas not related to the architectural setting of suspended strut rack installations as described above.

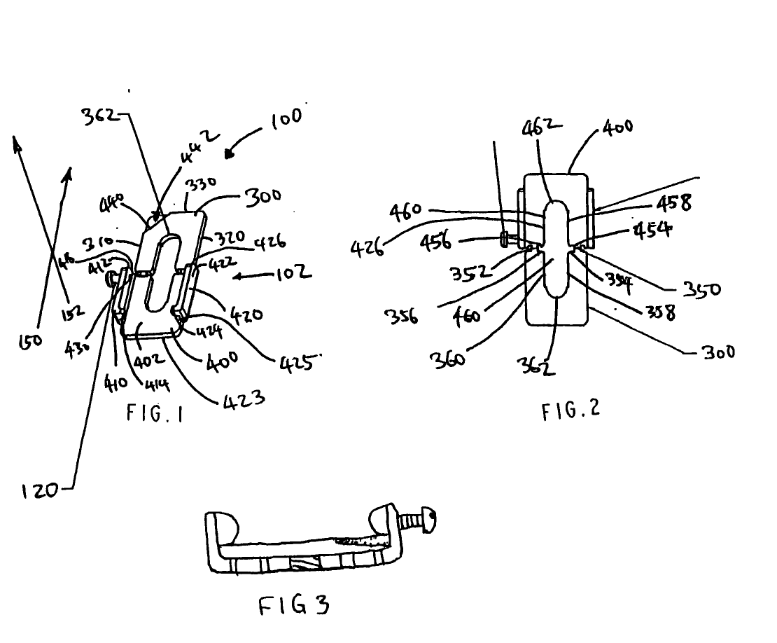

Referring now to the FIGS. 1 and 2, a snap-off sliding nut assembly 100 of the present invention is shown. Sliding nut assembly 100 includes a monolithically prefabricated body 102, which may be utilized in a previously installed suspended strut rack installation without removing any of its members. The sliding nut assembly 100 is manufactured with two distinct portions, the substantially rectangular receptacle portion 400 and the similarly shaped slider portion 300. The receptacle portion 400 is frangible attached to the slider portion 300 at fragile linking joints 350 and 352 located on either side of opening 460 defined by both portions 400 and 300. Opening 460 may be elliptical, oblong, or some other shape.

The slider portion 300 is substantially planar and rectangular in shape, and includes perimetrical side edges including two-sided surfaces 310, 320, and a distal edge surface 330 which is formed away from the proximate position at the conjoined linking joints 350, 352 which serve as breaking points.

The receptacle portion 400 also includes perimetrical side edges 410, and 420 with a distal edge surface 423. The two side surfaces 410, and 420, located at the outer perimeter of the receptacle portion 400, curvilinearly extend from the surface of portion 400 perpendicular to the axis 150, and parallel to the axis 152. The raised side surfaces 410, and 420, thus formed, provide a set of upper raised longitudinal guide ridges 412, and 422 at either sides of the main receptacle body 402. The width of the main body 402, as defined by the boundary of the guide ridges 412 and 422 at either ends, is slightly wider than the width of the slider portion 300. Therefore, when the slider portion 300 is detached from the receptacle portion 400 at frangible linking joints 350 and 352, the slider portion 300 can be accommodated between the set of raised longitudinal guide ridges 412, 422. In addition, the rectangular perimeter of the receptacle portion 400 can serve to abut against other architectural members and the monolithic planar nut body 402 can provide a handle-friendly surface.

As mentioned above, the receptacle portion 400 and the slider portion 300 are attached at frangible linking joints 350 and 352. The linking joints 350, 352 are formed with a specified tensile strength to maintain connection of the slider portion 300 with the receptacle portion 400 during transportation and also an easy to snap off narrow connection feature, which allow the receptacle portion 400 and the slider portion 300 to break off from each other by hand.

FIG. 1 also shows that the raised guide ridges 412 and 422, are not fully attached to the main body 402 along its longitudinal length. Instead, the distal portions 414, 424 of the raised guide ridges 412, 422 are separated from the main body 402 with a spacing 425 having a defined distance. Further, the distal portions 414 and 424 are bent inwardly toward each other to define an angled bend, thus creating a vertical guide for the slider portion 300. In essence, the thickness of the spacing 425 is at least greater than the thickness of the slider portion 300 such that the distal portions 414, 424 guide and retain the slider portion 300 from separating in the axis 152 direction away from the receptacle portion 400.

The proximate portion 416 of the raised guide ridge 412 includes a threaded hole 430 therethrough. This threaded hole 430 accommodates a screw 120, together forming tightening fastener sub-assembly in combination with the slider portion 300. Thus, the retaining slider mechanism, in effect, also functions as a part of the tightening fastener sub-assembly.

As can be seen in FIG. 2, the monolithic assembly body 402 includes an elongated inner opening 460 with the hole extended along axis 150 and defined with the aperture entries 354, 356 at the linking joints 350, 352. When the slider portion 300 is detached from the receptacle portion 400, the opening 460 extends from the aperture entries 354 and 356 at the linking joints 350, 352 along a pair of guide surfaces 358, and 360 into an internally threaded portion 362. As can be noted, the guide surfaces 358 and 360 are slightly wider than the internally threaded portion 362 to easily accommodate a threaded rod 98. Equally, at the receptacle portion 400, the elliptical opening 460 extends from the aperture entries 454, 456 located at the linking joints 350, 352 and runs along a pair of guide surfaces 458 and 461 and finally terminates into an internally threaded portion 462 to accommodate the threaded rod 98 in cooperation with the internally threaded portion 362 of the slider portion 300.

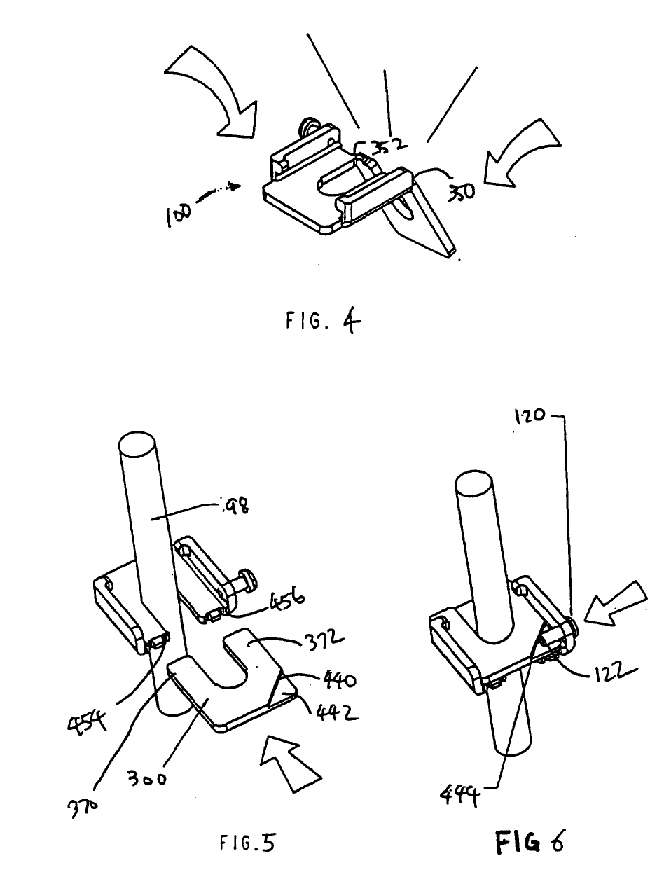

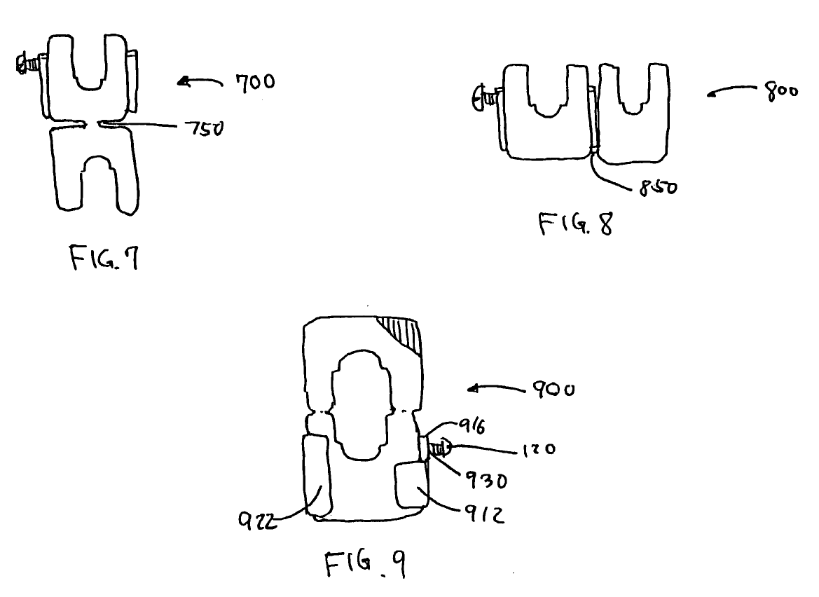

As can be seen in FIGS. 1, 3, 5 and 6, a ledge 440 is provided at one corner of the distal portion 330 with a substantially horizontal surface 442 and a vertical slanted surface 444. As can be readily seen in FIG. 6, this inclined corner ledge 440 is designed with a specific degree to interact with the screw 120. The specified degree corresponds to the length of the screw 120 such that as the screw 120 is tightened against the threaded hole 430 in the proximate portion 416, the tip of the screw 120 presses against the vertical angle wall surface 444, thereby sliding the slider portion 300 further into the receptacle portion 400 to firmly clasp the threaded rod 98. Thus, as the slider portion 300 tightens around the threaded rod 98, a tight support for the strut member (not shown) is accomplished. Preferably, the substantially horizontal surface also includes an incline or a set of graduated steps adapted to cooperate against the threads of the screw 120 and secure the slider portion 300.

In a preferred embodiment, the screw is provided as a captive screw provided in the threaded hole 430, so as to not fall off of the body 402. In addition, preferably, the screw 120 provides for a tightening fastener sub-assembly configured for disassembly and reuse of the hanger nut assembly.

The captive screw may also include split washers clipped on after the screw has been inserted in the panel, threaded panel holes used in conjunction with a screw that has an externally relieved shank, a long groove between the head and threads, or a ferrule or sleeve that is pressed, threaded, swaged, or flared to the parent material.

Having described the physical attributes of the sliding nut assembly 100, a preferred installation method of the sliding nut in a strut assembly shall be described in detail by referring to FIGS. 4, 5 and 6. FIG. 4 shows the preformed sliding nut assembly with the screw 120 already installed in the body 102. Initially, an installer snaps off the slider portion 300 from the receptacle portion 400 at the breaking point of linking joints 350, 352 so that the body 102 becomes two separate parts, the receptacle portion 400 and the slider portion 300.

Next, as seen in FIG. 5, the wide aperture entries 454, 456 of the rectangular receptacle portion 400 is placed around and accommodates the vertical shaft of the threaded rod 98. Optionally, the hanger nut assembly 100 may be installed upside down such that the bottom surface provides an abutting support body against a strut member. The installer then inserts the slider portion 300 toward the threaded rod 98 guided by the upper guide ridges 412 and 422 and the angled bend in a sliding mechanism. In other words, as these two separate portions 300 and 400 are combined together onto a threaded rod as shown in FIG. 6, the pair of tongues 370 and 372 of the slider portion 300 run along the upper side surface of the receptacle portion 400, between the guide ridges 412 and 422 and underneath the angled bends.

The installer further slides the slider portion 300 further into the receptacle portion 400 until the ledge 440 passes over the screw tip 122. Once the ledge 440 passes into the screw tip 122, the installer, then tightens the screw 120 further into the threaded hole 430, the tip 122 of the screw, pressing against the vertical surface 444 of the ledge 440, urging the slider portion 300 further toward the receptacle portion 400 and the shaft of the threaded rod 98. As the screw 120 is tightened further, the internal threaded portions 362 and 462 tighten around the shaft of the threaded rod 98.

Next, as the sliding nut assembly 100 is substantially tightened around the threaded rod 98, the sliding nut assembly 100 is rotatably moved up or down to a preferred position. If necessary, the sliding nut assembly 100 may be slightly repositioned along the shaft of the threaded rod 98 such that the whole assembly is aligned with the top wall of the strut. The sliding nut assembly 100 may be turned by hand or with a wrench to adjust the position to a level of the assembled strut member at the proper height. Then, the installer further tightens the screw 120 into the threaded hole 430 to firmly clamp the sliding nut assembly 100 in a threaded engagement with the threaded rod 98. This final step is shown in FIG. 6 wherein the screw 120 is tightened so that the end point tip 122 of the screw pushes the surface 444 so that the slider portion 300 is forcibly directed toward the threaded rod 98, ensuring that the slider portion 300 and the receptacle portion 400 are not separated. The sliding nut assembly 100, then can receive a strut member on top or the sliding nut assembly 100 can be lowered against the upper portion of the strut member. In this manner, the strut member cannot move up or down on the threaded rod 98, thus providing for support thereof.

The above method is then repeated to install additional strut assemblies on all the threaded rods to form a plurality of generally parallel strut assemblies capable of receiving and supporting pipes, cables, and the like thereon.

Once the sliding nut assembly 100 is positioned by a hand or a wrench, the steps are repeated to install additional slot assemblies on all the shafts to form a plurality of generally parallel sliding nut assemblies capable of receiving and supporting pipes, cables, and the like thereon.

To remove the cable strut assembly, the sliding nut assembly 100 can be quickly removed by untightening the screw 120 from the sliding nut assembly 100, and slidably retracting the slider portion 300 away from the receptacle portion 400, allowing the assembled struts to slide off the threaded rod 98.

The above described apparatus and method provides for a sliding nut assembly with a strut rack system which may be installed as original equipment to become the primary strut rack or maybe even be quickly installed as an intermediate or upper rack above existing strut racks without the necessity of removing any members already in place.

The sliding nut assembly 100, manufactured as described above, can be produced from metal, hardened plastic, or elastomer. Further, such sliding nut assembly can be manufactured by different processes, extrusions, machining, or stamping or combinations of any previously described processes.

Additionally, different types of monolithic body may be manufactured according to the present invention. FIGS. 7 and 8 show variations of the monolithic nut assembly body 600 and 700 respectively, where the linking joints 750, 850 respectively are shown at different locations on the body. In essence, the joint is provided at side edges away from the access openings.

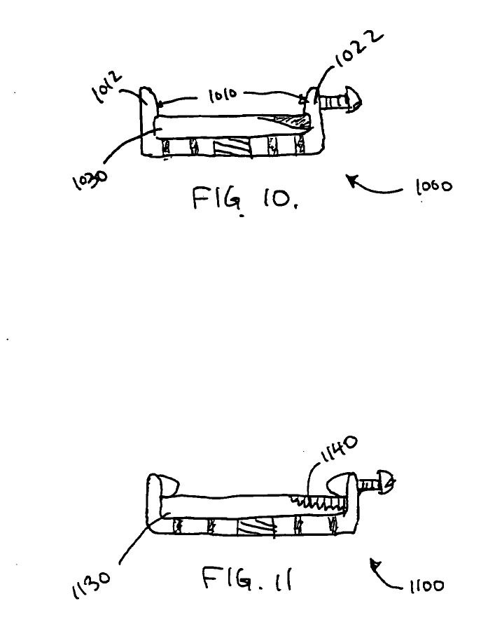

Further, different types of guiding member may be produced according to the present invention. Specifically, FIGS. 9 and 10 show different embodiments of the sliding nut assembly. FIG. 9 shows the ridge portions which have been raised from the main body, and then, bent toward each other at angles parallel to the axis 150. As can be noted, the ridge portion 916 is left intact and includes a threaded hole 930 to accommodate a screw 120. Thus, guide members 912 and 922 also provide for a surface to abut architectural structures against, such as the strut members.

FIG. 10 shows ridge portions defining a narrower width than the width of the sliding member 1030. Thus fabricated, the slider portion 1030 can be snapped onto the receptacle portion in between the ridge portions 1012 and 1022 instead of sliding in between the portions 1012 and 1022. Thus, the receptacle portion accommodates the slider portion 1030 in a snap-on configuration.

Further, other additional features are envisioned by the present invention. For instance, FIG. 11 shows the incline portion of the slider portion 1130, wherein the incline is further accented by grooves and peaks 1140. These grooves and peaks 1140 correspond to the threads of the screw member 120 as the screw is twisted into the slider portion 300. Thus, the thread members of the distal portion 122 of screw 120 interacts with the grooves and peaks 1140 on the ledge to provide for a more secure receptacle-slider portion combination.

A different type of tightening fastener sub-assembly is envisioned wherein a third clasping member may be provided to clasp the receptacle portion and the slider portion or a clip or other types thereof.

It should be understood that other types of fasteners other than the sliding nut may be used to secure the sliding nut members together. For example, a bolt or a nail may be used instead of a screw.

The particular preferred disclosed embodiments and practices are intended in a descriptive sense and are not limiting. The scope of the invention is set forth in the following claims.

What is claimed is:

1. A hanger nut assembly for supporting a strut to a threaded rod extending through the strut, the assembly comprising:
a generally planar body having a receptacle portion coupled to a slider portion at a frangible joint, said body defining a bounded opening between said receptacle portion and said slider portion; and
said slider portion being frangibly detachable from said receptacle portion at said joint, and slidably insertable into said receptacle portion for securement about said threaded rod.

2. A hanger nut assembly according to claim 1, wherein said receptacle portion has a substantially rectangular perimeter with a pair of raised side edges forming a retaining sliding mechanism of a guide tray for accommodating said slider portion.

3. A hanger nut assembly according to claim 2, further including a tightening fastener sub-assembly configured for disassembly and reuse of the hanger nut assembly.

4. A hanger nut assembly according to claim 2, further including a screw, wherein one said side edge includes a threaded hole to accommodate said screw and a corner of said slider portion includes a ledge adapted to cooperate with said screw and move said slider portion toward said receptacle portion and clamp around the threaded rod as the tip of said screw presses along said ledge.

5. A hanger nut assembly according to claim 4, wherein said corner includes a horizontally graduated surface adapted to cooperate against the threads of said screw to secure said slider portion.

6. A hanger nut assembly according to claim 1, wherein said joint and another similarly placed joint together define the entry of said access opening.

7. A hanger nut assembly according to claim 1, wherein the hanger nut assembly is installed upside down and said bottom surface provides an abutting support body against a strut member.

8. A hanger nut assembly according to claim 2, wherein said rectangular perimeter abuts against other architectural members and said planar nut body provides a handle-friendly surface.

9. A hanger nut assembly according to claim 1, wherein said opening is wider than an internally threaded portion to easily accommodate the threaded rod.

10. A hanger nut assembly according to claim 1, wherein said joint is formed with a specified tensile strength to maintain connection of said slider portion with said receptacle portion during transportation and to easily snap off and detach by hand.

11. A hanger nut assembly according to claim 4, wherein said screw is a captive screw provided in said threaded hole so as to prevent disengagement from said body.

12. A hanger nut assembly according to claim 3, wherein said retaining slider mechanism includes a part of said tightening fastener sub-assembly.

13. A hanger nut assembly according to claim 2, wherein said raised edges define a width therebetween slightly narrower than the width of said slider portion to accommodate said slider portion in a snap-on configuration.

14. A hanger nut assembly according to claim 5, wherein said horizontally graduated surface includes grooves and peaks to interact with the thread portion of said screw.

15. A hanger nut assembly according to claim 1, wherein said joint is provided at side edges away from said opening.

16. A hanger nut assembly according to claim 10, wherein said slider portion is attached at a slightly elevated position in relation to said receptacle portion at said joint.

17. A sliding nut comprising:
a screw;
a substantially planar receptacle structure with a first aperture entry extending to a first internally threaded portion of said receptacle structure; and
a substantially planar slider structure with a second aperture entry extending to a second internally threaded portion of said slider structure, said first and second aperture entries defining a closure for accommodating a threaded rod, said receptacle structure including a pair of upper ridges defining a guide tray for accommodating said slider structure and a threaded hole in at least one said ridge for said screw, a corner of said slider structure including a slanted surface adapted to cooperate with the tip of said screw and move said slider structure toward said receptacle structure to clamp the sliding nut around said threaded rod.

18. A method of supporting a strut having a threaded rod extending therethrough, the method comprising the steps of:
providing a preformed substantially planar receptacle portion and a substantially planar slider portion, each said portion including an access opening extending to an internally threaded portion for insertable accommodation of the threaded rod;
engaging said slider portion with said receptacle portion, wherein said receptacle portion includes a pair of upper ridges forming a retaining sliding mechanism for accommodating said slider portion, at least one of said ridges having a threaded hole;
turning said receptacle portion and said slider portion upside down;
guiding the internally threaded portion of said receptacle portion around the threaded rod;
guiding said internally threaded portion of said slider portion into said sliding mechanism of said receptacle portion, wherein a corner said slider portion includes a slanted surface adapted to cooperate with a screw and drive said slider portion toward said receptacle portion to clamp around said threaded rod;
turning said screw through said threaded hole to hold said receptacle portion and said slider portion together against said threaded rod;
moving said receptacle portion up or down on said threaded rod to a desired position; and
tightening said screw to securely clamp said receptacle portion and said slider portion on said threaded rod;

19. A method of according to claim 18, further including the step of:
untightening said screw to remove or move said receptacle portion to a different position for disassembly and reuse.

20. A method according to claim 18, further including the steps of:
repeating said steps to install additional strut assemblies on all the threaded rods to form a plurality of generally parallel strut assemblies capable of receiving and supporting pipes, cables, and the like thereon.
